(19) United States
(12) Patent Application Publication
(10) Pub. No.: US 2015/0053045 A1
(43) Pub. Date: Feb. 26, 2015

(54) FLAT BICYCLE PEDAL

(71) Applicant: Ali Barjesteh, Berlin (DE)

(72) Inventor: Ali Barjesteh, Berlin (DE)

(21) Appl. No.: 14/380,819

(22) PCT Filed: Feb. 20, 2013
(86) PCT No.: PCT/DE2013/000101

§ 371 Date: Aug. 25, 2014

(30) Foreign Application Priority Data
Feb. 24, 2012 (DE) 10 2012 004 011.3
Feb. 24, 2012 (DE) 20 2012 002 085.4

(51) Int. Cl. B62M 3/08

(52) U.S. Cl. CPC B62M 3/08
USPC 74/594.4

(57) ABSTRACT

The invention concerns a flat bicycle pedal made of two half shells (1, 2) connected with each other and a pedal axle (6), whereby each half shell (1, 2) consists of a tread plate (3) and a honey comb-like structure (4) fixedly connected with the respective tread plate (3) and, whereby the honey comb-like structures (4) lie consecutively in assembled condition, each of the half shells (1, 2) in the honeycomb-like structure (4) show sliding bearing half shells (5) for the pedal axle (6) and in each sliding bearing half shell (5) minimum two semicircular grooves (7) are arranged for the acceptance of annular ridges (8) of the pedal axle (6).

The invention concerns a flat bicycle pedal especially for BMX-bicycles.

Such a bicycle pedal has been described in the DE 10 2007 034882 AI and consists of a fully flat kick plate and a fully flat counter plate, which is designed identically, so that depending on position of the pedal the tread plate can also be counter plate and vice versa. Between the tread plate and the counter plate a distance body is arranged ensuring distance between tread plate and counter plate, which shows a bore for acceptance of a bearing unit for the pedal axle, whereby the remaining material between the drill hole and outer surface of the distance body approaches zero so that the load transmission takes place almost directly from the tread plate directly to the bearing unit. The connection of kick- and counter-plate takes place through at least two connection elements which are respectively arranged on both sides of the bearing unit and ensures the fixation of the bearing unit.

The task of the invention is to continue and thereby improve this solution principle.

This task is solved with the features of claim 1, advantageous arrangements are subject of the dependent claims.

For a flat bicycle pedal made of two half shells connected to each other and a pedal axle it is suggested according to the invention that each half shell consists of a tread plate and a honeycomb structure fixedly connected with the respective tread plate, whereby the honeycomb-type structures lie on each other in assembled conditions, each of the half shell in the honeycomb-type structure shows a sliding bearing half shell for the pedal axle and in each sliding bearing half shells minimum two semicircular grooves are arranged for acceptance of circular grooves of pedal axle.

Thereby the thickness of the sliding bearing half shells on apex for tread plate is less than 3 mm so that the pedal thickness essentially is determined by the strength of the tread plate and diameter of the pedal axle.

The distributed load of the tread plate is transferred optimally on the pedal axle and in pedal axle forces working in longitudinal direction are accepted through the circular groove-ring web-pairings.

In an advantageous execution it is intended that the number of circular grooves of the pedal axle is smaller than the number of circular grooves arising at the time of assembly of sliding bearing half shells. Thus the pedal axle can be arranged in various positions in the pedal, i.e. the distance between pedal and foot pedal can be changed.

In sense of the design of the bicycle pedal as flat body it is intended in case of a further advantageous execution that the diameter of circular grooves of the pedal axle is smaller or same to the diameter of the pedal axle or smaller or same to the distance between the tread plates.

The circular grooves are developed in case of preferred execution from the pedal axle. It is also naturally possible that at least a circular web, preferably the exterior ring web, is through a ball bearing fixedly connected with the pedal axle.

In a preferred execution the sliding bearing half shells are closed on pedal outside surface and the circular grooves of pedal axle are arranged on the end area of the pedal axle lying in the pedal.

It has further proved as advantageous if sliding bearing half shells in outlet area of pedal axle from the pedal show a groove shaped recess for assignment of a sealing ring. The tribological coating between the pedal axle and the sliding bearing half shells is protected from dust and humidity.

The sliding bearing half shells can be manufactured from a different friction bearing material from that of honeycomb-type structure or of the same material however with an additional bearing coating.

The honeycomb-type structure preferably consists of bodies bearing against each other with a preferably β-angled cross section. The honeycomb-type structure building bodies are executed minimum partially as hollow bodies. Nuclear bodies can thereby show common partitions. Full bodies contain the necessary bores for the connecting elements between the half shells. Thereby it preferably concerns bolted assembly.

In addition to the structure set out above, a hexagonal cross section and the honeycomb-type structure for building bodies, the bodies can also be truncated cones, truncated pyramids, or cylinder or combinations of the same. In case of further advantageous design it is intended that the assembled half shells are cased with circulated edge guard, whereby this shows an opening for the pedal axle, preferably a groove. On both sides of the groove mounting points can be arranged, which engages in hollows of the honeycomb-type structure.

In case of a further execution the edge guard is formed directly to the honeycomb-type structure and preferably made of the same material as this.

It is further intended that in case of an advantageous execution which shows a misalignment of half shells assembled to a pedal, so that the surface line of the pedal after the assembly essentially runs in parallelogram form in a vertical level to the pedal axle.

The edge guard then has an internal wall structure, through which the distances arising at the time of assembly between the honeycomb-type structures of the shifted arranged tread plates can be compensated.

The edge guard can also overlap the tread plates at least section wise, which minimizes the risk of slipping.

A further design intended that the bicycle pedal shows aligned gaps through the half shells, preferably one on each pedal axle side, so that impurities of the pedal can enter through this. Execution examples and details are shown in the figures. They show:

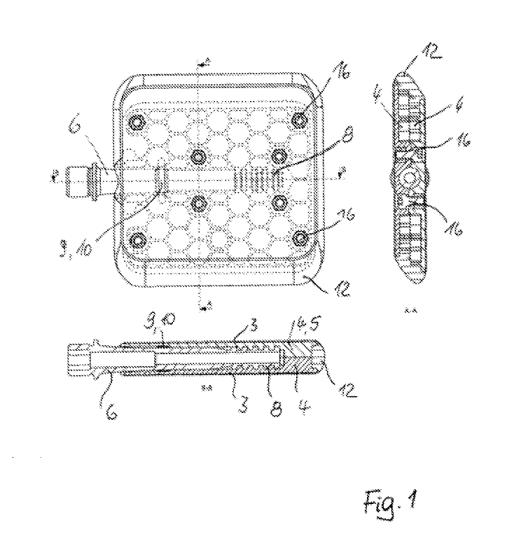

FIG. 1 Pedal with Pedal axle,

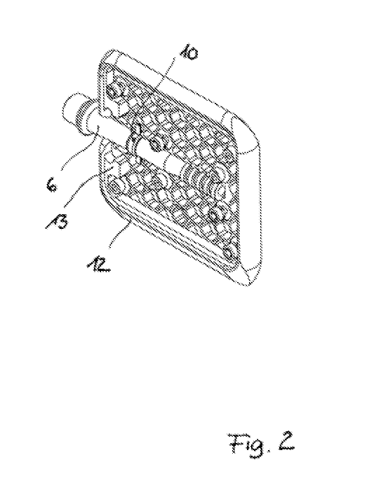

FIG. 2 a half shell with Pedal axle,

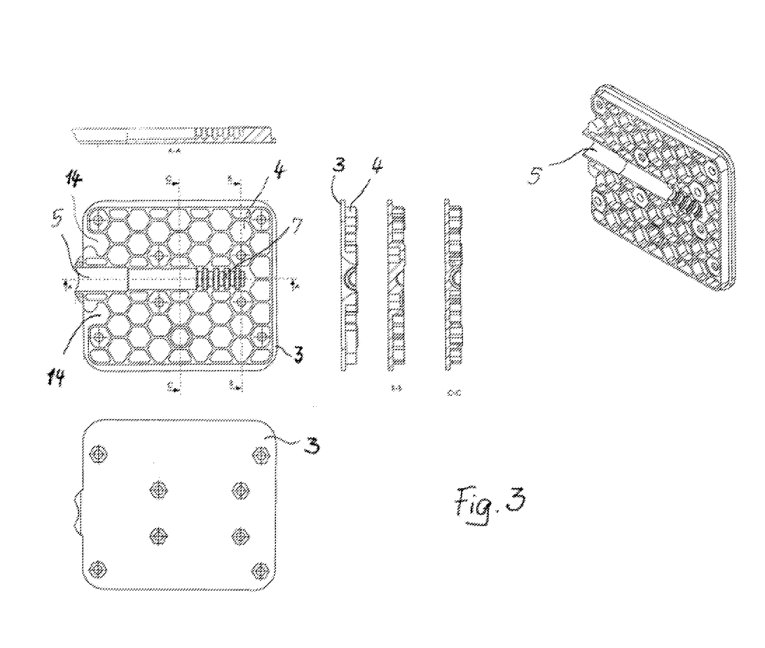

FIG. 3 a Half shell with sliding bearing half shells and

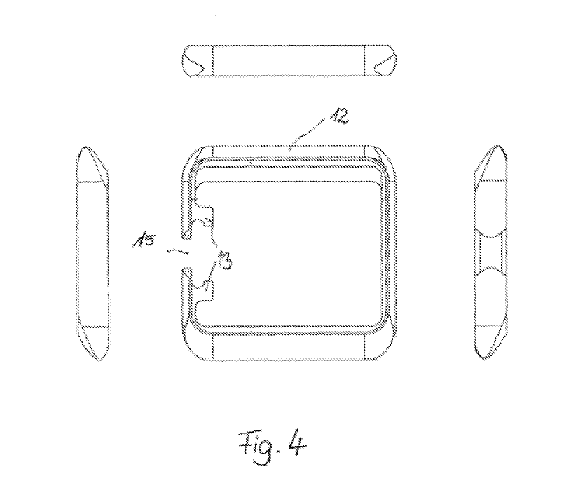

FIG. 4 an Edge guard.

FIG. 1 Shows a pedal with Pedal axle 6 in a plan view and in two sections.

The bicycle pedal consists of two half shells 1, 2 connected to each other and a pedal axle 6, whereby each half shell 1, 2 consists of a tread plate 3 and a honey comb-like structure 4 connected firmly with the respective tread plate 3, whereby the honeycomb-type structures 4 lie consecutively in assembled condition.

Both the half shells 1, 2 are connected with each other through bolting screws 16. Each of the half shells 1, 2 shows in the honeycomb-type structure 4 a sliding bearing half shells 5 for the pedal axle 6 and in each sliding bearing half shells 5 four semicircular grooves 7 for acceptance of four circular grooves 8 of the pedal axle 6 are arranged. In each circular groove 7 at the time of execution thus a Ring web 8 of Pedal axle 6 catches. The circular grooves 8 of pedal axle 6 are arranged in pedal lying end area of the pedal axle 6.

If the number of circular grooves 8 of the pedal axle 6 is smaller than the number of circular grooves selected at the time of assembly of sliding bearing half shells 5, the pedal axle 6 is arranged prominently against the shown position somewhat further from the pedal. The thickness of the sliding bearing half shells 5 on apex point (S) for tread plate 3 is smaller than 3 mm.

It is further shown that the sliding bearing half shells 5 show a groove form Hollow 9 for acceptance of a sealing ring 10 in the outlet area of pedal axle 6 from the pedal. This can also consist of two half shells.

In section AA it can be identified that the sliding bearing half shells 5 show a misalignment of half shells 1, 2 assembled to a pedal to each other in the honeycomb-type structure 4, so that the surface line of the pedal runs in a vertical level for pedal axle 6 in a parallelogram. The circular edge guard 12 therefore has an internal wall structure, through which the distances arising at the time of assembly between the honeycomb-type structures 4 of the shifted arranged tread plates 3 can be compensated.

The shown pedal has a thickness of 14.5 mm in the illustrated execution.

FIG. 2 shows a half shell 1 with pedal axle 6 and edge guard 12. The pedal axle 6 has circular grooves 8 in its end section, whereby the diameter of the circular grooves 8 of the pedal axle 6 is selected smaller or same to the diameter of the pedal axle 6 or smaller or same to the distance between the tread plates 3.

On the tread plate 3 and connected with this there is honeycomb-type structure 4, in which the sliding bearing half shells 5 are shown for the pedal axle 6.

The sliding bearing half shells 5 are closed on pedal outside surface. The honeycomb-type structure 4 consists of preferably 6-angled cross section of bodies lying together (11). Except for the one body 11 used for acceptance of bolting screws 16, the bodies 11 are shown as hollow bodies.

It is further shown that the circular edge guard 12 shows an opening for the pedal axle 6, preferably a groove 15. The edge guard 12 shows mounting points 13 on both sides of the groove 15, which enter in hollows 14 of the honeycomb-type structure 4.

FIG. 3 shows a half shell 1 in several views and sections without pedal axle 6. On the tread plate 3 and connected firmly thereto, there is the honeycomb-type structure 4 made of bodies 11 with 6-angled cross section. In the honeycomb-type structure 4 the sliding bearing half shells 5 are arranged with four grooves. The sliding bearing half shells 5 are closed closed on pedal outside surface and overlaps the exterior edge of the pedal in the area of outlet for the pedal axle 6. Together with the edge guard 12 thus an esthetic solution is achieved. Even the hollows 14 can be recognized in the honeycomb structure 4 for acceptance of the mounting points 13 of the edge guard 12. The mounting points 13 engaged the exterior edge of the hollows 14 and thus take care of high cohesiveness.

FIG. 4 shows in a detail view the edge guard 12 with the groove 15 for continuity of pedal axle and mounting points 13.

### REFERENCE NUMERAL LIST

1 Half shell
2 Half shell
3 Tread plate
4 honeycomb-type structure
5 Sliding bearing half shells
6 Pedal axle
7 Grooves of sliding bearing half shells
8 Circular grooves of pedal axle
9 Groove shaped recess of sliding bearing half shells
10 Sealing ring
11 Body of honeycomb structure
12 Edge guard
13 Mounting points of edge guard
14 Hollows in honeycomb structure
15 Groove of edge guard
16 Bolting screws

I claim:

1. A flat bicycle pedal comprising:
two half shells connected with each other and a pedal axle wherein each half shell includes
a tread plate and
a honeycomb-like structure fixedly connected with the respective tread plate,
wherein the honeycomb-like structures lie consecutively in assembled condition, each half shell in the honeycomb-type structure including sliding bearing half shells for the pedal axle and in each sliding bearing half shells at least two semicircular grooves are arranged for acceptance of annular ridges of the pedal axle.

2. The flat bicycle pedal of claim 1, wherein the thickness of the sliding bearing half shells on an apex point for the tread plate is smaller than 3 mm.

3. The flat bicycle pedal of claim 1, wherein the number of annular ridges of pedal axle is smaller or the same as the number of circular grooves arising at the time of assembly of sliding bearing half shells.

4. The flat bicycle pedal of claim 1, wherein the sliding bearing half shells are closed on the pedal outside surface.

5. The flat bicycle pedal of claim 1, wherein the sliding bearing half shells are manufactured from a slide bearing material different from the honeycomb-type structure.

6. The flat bicycle pedal of claim 1, wherein the diameter of annular ridges of the pedal axle is smaller or same to the diameter of the pedal axle or smaller or the same as the distance between the tread plates.

7. The flat bicycle pedal of claim 1, wherein the annular ridges of the pedal axle are arranged on the end area of the pedal axle in pedal.

8. The flat bicycle pedal-of claim 1, wherein at least one ring web includes a ball bearing a fixedly connected-with the pedal axle.

9. The flat bicycle pedal-of claim 1, wherein the sliding bearing half shells in the outlet area of the Pedal axle from the pedal show a groove shaped recess for acceptance of the sealing ring.

10. The flat bicycle pedal of claim 1, wherein the honeycomb-like structure is made of a 6-angled cross section of bodies lying together.

11. The flat bicycle pedal of claim 1, wherein the honeycomb-type structure building bodies are truncated cones, truncated pyramids or cylinders.

12. The flat bicycle pedal of claim 1, wherein the honeycomb-type structure building bodies are at least partially hollow bodies.

13. The flat bicycle pedal of claim 1, wherein the uniform half shells are cased with a circular edge guard, including an opening for the pedal axle.

14. The flat bicycle pedal of claim 13, wherein the edge guard on both sides of grooves shows mounting points, positioned in hollows of the honeycomb-type structure.

15. The flat bicycle pedal of claim 13, wherein the edge guard is directly formed to the honeycomb-type structure.

16. The flat bicycle pedal of 13, wherein the edge guard overlaps the tread plates.

17. The flat bicycle pedal of claim 1, wherein the half shells assembled to a pedal are misaligned, so that the surface line of the pedal after assembly describes a parallelogram.

18. The flat bicycle pedal of claim 17, wherein the edge guard has an internal structure, through which the distances arising at the time of assembly between honeycomb-type structures which shifts arranged tread plates can be compensated.

19. The flat bicycle pedal of claim 1, wherein the bicycle pedal shows aligned gaps through the half shells, at least on one side of each pedal axle.
